(19) United States
(12) Patent Application Publication
(10) Pub. No.: US 2007/0015408 A1
(43) Pub. Date: Jan. 18, 2007

(54) Apparatus and method of removing a protection sheet

(76) Inventors: Wun-Bong Tak, Asan-si (KR); Dong-Suk Park, Cheonan-si (KR); Sung-Su Lee, Cheonan-si (KR)

Correspondence Address: CANTOR COLBURN, LLP, 55 GRIFFIN ROAD SOUTH, BLOOMFIELD, CT, 06002, US

(21) Appl. No.: 11/485,111

(22) Filed: Jul. 12, 2006

(30) Foreign Application Priority Data
Jul. 14, 2005 (KR) 2005-63795

(51) Int. Cl. H01R 13/648

(52) U.S. Cl. 439/607

(57) ABSTRACT

An apparatus for removing a protection sheet includes a body, a labeling unit, a clamping unit and a protection sheet stacking unit. The labeling unit is on the body and attaches a label on a protection sheet disposed on a polarizer of a display panel. The clamping unit is on the body and includes a clamping part and a clamp transporting part. The clamping part clamps the label. The clamp transporting part transports the clamping part so that the protection sheet is stripped from the polarizer. The protection sheet stacking unit is on the body and receives the protection sheet that is stripped from the polarizer.

This application claims priority to Korean Patent Application No. 2005-63795, filed on Jul. 14, 2005, and all the benefits accruing therefrom under 35 U.S.C. §119, the contents of which are hereby incorporated herein by reference in its entirety.

### BACKGROUND OF THE INVENTION

1. Field of the Invention

The present invention relates to an apparatus for removing a protection sheet and a method of removing the protection sheet. More particularly, the present invention relates to an apparatus for removing a protection sheet from a polarizer and a method of removing the protection sheet from the polarizer.

2. Description of the Related Art

A liquid crystal display (LCD) panel includes a polarizer for displaying images.

Two polarizers, in general, are on a light incident surface and a light exiting surface of the LCD panel, respectively. When the LCD panel includes a twisted nematic liquid crystal, polarizing axes of the polarizers are substantially perpendicular to each other.

The polarizers are attached to the light incident surface and the light exiting surface, respectively. Protection sheets are attached on the polarizers to protect the polarizers from an impact or external force of subsequent processes during assembly and manufacturing. When the LCD panel is completed, the protection sheets are removed from the polarizers, respectively.

However, the protection sheets have a substantially same size as the polarizers so that the protection sheets may not be easily removed from the polarizers. In addition, the polarizers may be damaged during removing the protection sheets.

### BRIEF SUMMARY OF THE INVENTION

One exemplary embodiment provides an apparatus for removing a protection sheet from a polarizer.

Another exemplary embodiment provides a method of removing the protection sheet from the polarizer.

In one exemplary embodiment of an apparatus for removing a protection sheet in accordance with the present invention, the apparatus includes a body, a labeling unit, a clamping unit and a protection sheet stacking unit. The labeling unit is on the body and attaches a label on a protection sheet disposed on a polarizer of a display panel. The clamping unit is on the body and includes a clamping part and a clamp transporting part. The clamping part clamps the label. The clamp transporting part transports the clamping part so that the protection sheet is stripped from the polarizer. The protection sheet stacking unit is on the body and receives the protection sheet that is detached from the polarizer.

In another exemplary embodiment of an apparatus for removing a protection sheet in accordance with the present invention, the apparatus includes a body, a first labeling unit, a first clamping unit, a first protection sheet stacking unit, a second labeling unit, a second clamping unit and a second protection sheet stacking unit. The first labeling unit is on the body and attaches a first label on a first protection sheet disposed on a first polarizer attached to a first surface of a display panel. The first clamping unit is on the body and includes a first clamping part and a first clamp transporting part. The first clamping part clamps the first label. The first clamp transporting part transports the first clamping part so that the first protection sheet is detached from the first polarizer. The first protection sheet stacking unit is on the body and receives the first protection sheet that is detached from the first polarizer. The second labeling unit is on the body and attaches a second label on a second protection sheet disposed on a second polarizer that is attached to a second surface of the display panel. The second clamping unit is on the body and includes a second clamping part and a second clamp transporting part. The second clamping part clamps the second label. The second clamp transporting part transports the second clamping part so that the second protection sheet is stripped from the second polarizer. The second protection sheet stacking unit is on the body and receives the second protection sheet detached from the second polarizer.

In another exemplary embodiment, a method for removing a protection sheet in accordance with the present invention is provided. The method includes, attaching a label is attached to a protection sheet disposed on a polarizer of a display panel, moving the label so that the protection sheet is removed from the polarizer, injecting a material discharging a static charge into a space between the protection sheet and the polarizer and ejecting the protection sheet that is removed from the polarizer is ejected.

In another exemplary embodiment according to the present invention, the protection sheet that is attached to the polarizer is easily removed from the polarizer. In addition, the static charge formed between the polarizer and the protection sheet may also be discharged. Furthermore, a time period for manufacturing the display device is decreased. Therefore, a yield of the display panel is improved.

### BRIEF DESCRIPTION OF THE DRAWINGS

The above and other advantages of the present invention will become more apparent by describing in detail exemplary embodiments thereof with reference to the accompanying drawings, in which:

FIG. 1 is a cross-sectional view showing an exemplary embodiment of a display panel including a protection sheet that may be removed by an apparatus for removing the protection sheet in accordance with the present invention;

FIG. 2 is a block diagram showing an exemplary embodiment of the apparatus for removing the protection sheet shown in FIG. 1;

FIG. 3 is a cross-sectional view showing an exemplary embodiment of a labeling unit shown in FIG. 2;

FIG. 4 is a plan view showing an exemplary embodiment of a labeled sheet and a label shown in FIG. 3;

FIG. 5 is an enlarged cross-sectional view showing portion ‘A’ shown in FIG. 3;

FIG. 6 is a plan view showing an exemplary embodiment of a label that is labeled on the protection sheet using a label picker shown in FIG. 3;

FIG. 7 is a cross-sectional view showing an exemplary embodiment of a clamping unit shown in FIG. 2;

FIG. 8 is a cross-sectional view showing another exemplary embodiment of a clamping unit in accordance with the present invention;

FIG. 9 is a cross-sectional view showing another exemplary embodiment of a display panel including a protection sheet that may be removed by an apparatus for removing the protection sheet in accordance with the present invention;

FIG. 10 is a block diagram showing another exemplary embodiment of the apparatus for removing the protection sheet in accordance with the present invention;

FIG. 11 is a cross-sectional view showing an exemplary embodiment of a labeling unit shown in FIG. 10;

FIG. 12 is a cross-sectional view showing an exemplary embodiment of a first clamping unit shown in FIG. 10;

FIG. 13 is a cross-sectional view showing an exemplary embodiment of a first protection sheet stacking unit shown in FIG. 10;

FIG. 14 is a cross-sectional view showing an exemplary embodiment of a second protection sheet stacking unit shown in FIG. 10;

FIG. 15 is a cross-sectional view showing another exemplary embodiment of a clamping unit in accordance with the present invention; and

FIG. 16 is a flow chart showing an exemplary embodiment of a method of removing a protection sheet in accordance with the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” or “under” relative to other elements or features would then be oriented “above” the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

FIG. 1 is a cross-sectional view showing an exemplary embodiment of a display panel including a protection sheet that may be removed by an apparatus for removing the protection sheet in accordance with the present invention.

Referring to FIG. 1, the display panel 10 includes a thin film transistor (TFT) substrate 1, a color filter substrate 3 corresponding to the TFT substrate 1, a liquid crystal layer (not shown) and a polarizer 6. The liquid crystal layer (not shown) is interposed between the TFT substrate 1 and the color filter substrate 3. The display panel 10 may have a substantially rectangular shape when viewed on a plane. The TFT substrate 1, color filter substrate 3 and polarizer 6 may correspond substantially in shape, size or positional placement relative to each other.

In FIG. 1, two polarizers 6 are illustrated in the display panel 1, one polarizer 6 being disposed on the TFT substrate 1 and the other polarizer 6 being disposed on the color filter substrate 3. Two protection sheets 7 are disposed on the polarizers 6, respectively. Each of the polarizers 6 and the protection sheets 7 has a substantially same shape as the display panel 10 when viewed on the plane. While two polarizers 6 and two protection sheets 7 are shown, any of a number of polarizers 6 and protection sheets 7 may be employed as is suitable for the purposes described herein.

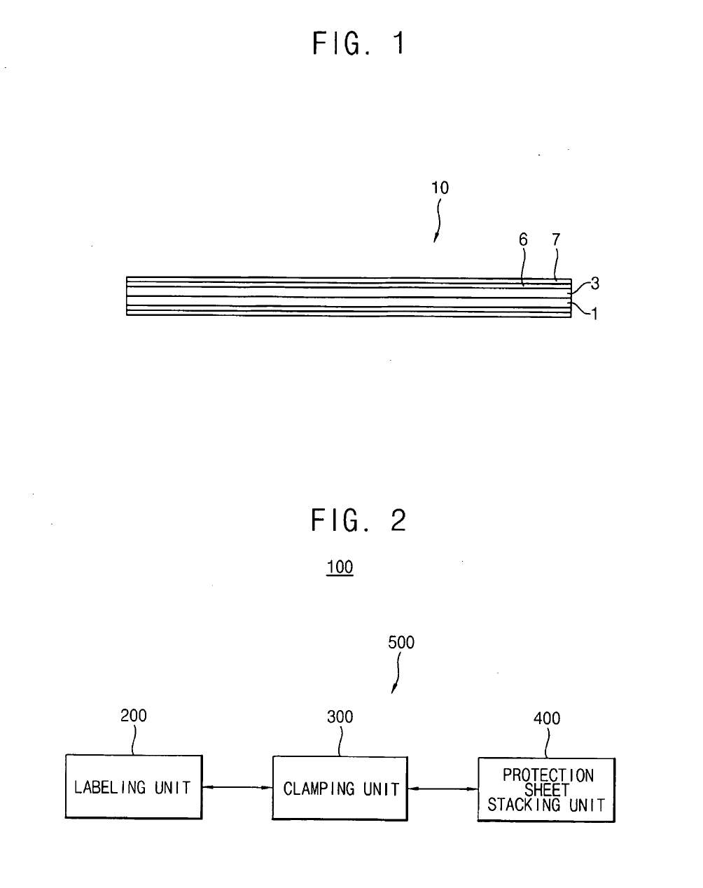

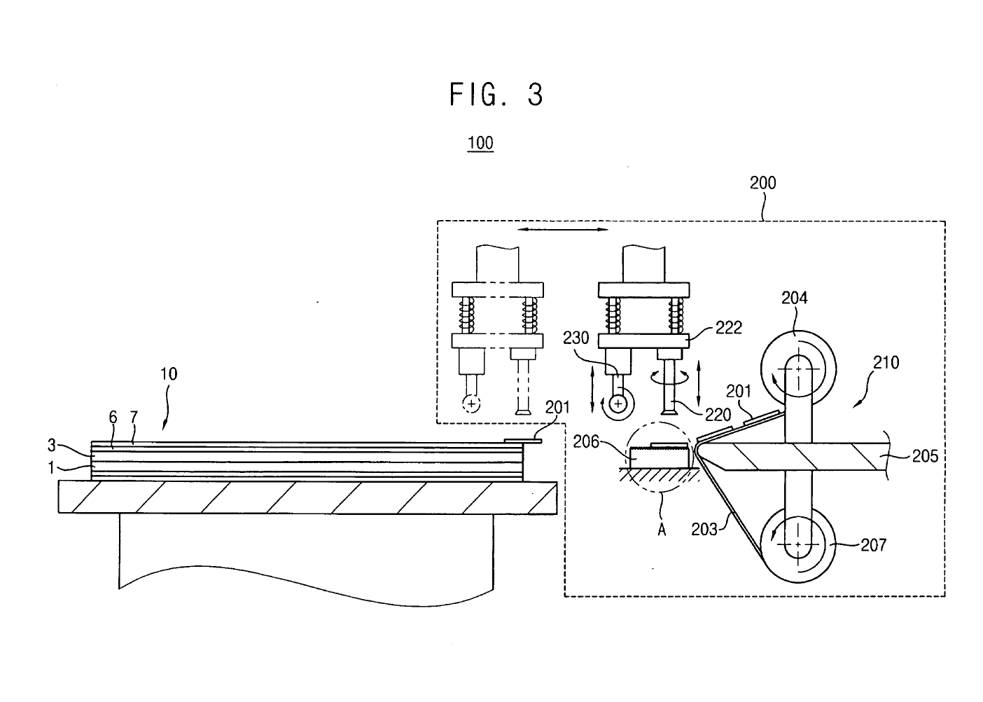

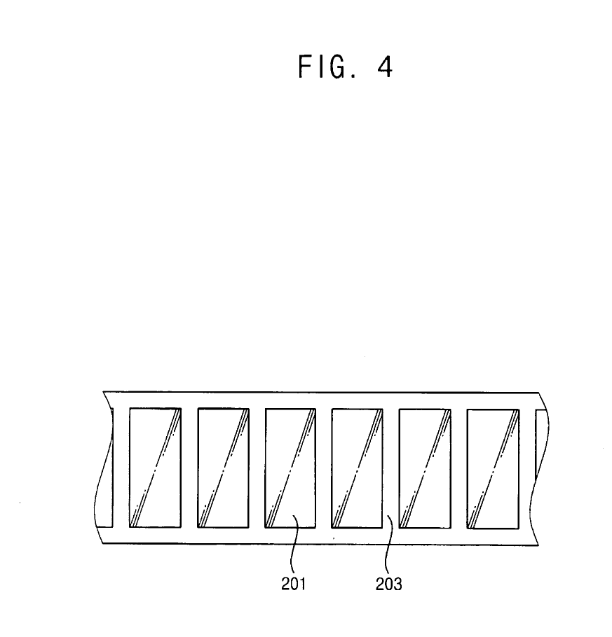

FIG. 2 is a block diagram showing an exemplary embodiment of the apparatus for removing the protection sheet shown in FIG. 1. FIG. 3 is a cross-sectional view showing an exemplary embodiment of a labeling unit shown in FIG. 2.

Referring to FIGS. 2 and 3, the apparatus 500 for removing the protection sheet includes a body 100, a labeling unit 200, a clamping unit 300 and a protection sheet stacking unit 400.

The labeling unit 200, the clamping unit 300 and the protection sheet stacking unit 400 are on the body 100.

Referring to FIG. 3, the labeling unit 200 attaches a label 201 on the protection sheet 7 attached on the polarizer 6 including in the display panel 10. The label 201 may be placed at any of a number of locations on the protection sheet 7. In one exemplary embodiment, the labeling unit 200 attaches the label 201 adjacent a corner of the protection sheet 7.

The labeling unit 200 includes a label separating part 210, a label picker 220 and a compressing part 230.

The label separating part 210 includes a label source 204 that is preferably a sheet roll, a separation device 205 that is preferably a separation plate, a label supporter 206 and a label source collector 207 that is preferably a sheet collecting roll. A label sheet 203 having the label 201 on a surface of the label sheet 203 is rolled in the label sheet roll 204. The separation plate 205 essentially removes the label 201 from the label sheet 203 as the label sheet 203 is processed with the separation plate 205. The label supporter 206 supports the label 201 that is separated from the label sheet 203. The label sheet collecting roll 207 collects the label sheet 203 from which the label 201 is removed. While a sheet roll is described as the label source, a sheet collecting roll is described as the label source collector and a separation plate is described as the separation device, it should be understood that other embodiments of a label source, label source collector and separation device would also be within the scope of these embodiments.

The label sheet roll 204 is shown disposed on (or over) the separation plate 205, and the label sheet collecting roll 207 is disposed under the separation plate 205. A driving device, such as a motor (not shown), may be mounted on the label sheet collecting roll 207 such that the label sheet 203 is transported from the label sheet roll 204 toward the label sheet collecting roll 207.

The label sheet 203 having the label 201 is essentially bent by the separation plate 205 so that the label 201 is separated from the label sheet 203. In one exemplary embodiment, the label sheet 203 is bent as it passes over a surface or an edge of the separation plate 205. That is, the label 201 is gradually separated from the label sheet 203 by the separation plate 205.

FIG. 4 is a plan view showing an exemplary embodiment of a labeled sheet and a label shown in FIG. 3.

Referring to FIG. 4, the label sheet 203 may include a substantially rectangular shape, and the label 201 is on the surface of the label sheet 203. The label 201 may have a substantially rectangular shape when viewed on a plane, and a longitudinal direction of the label 201 may be substantially perpendicular to a longitudinal direction of the label sheet 203.

Referring again to FIG. 3, the label 201 that is separated from the label sheet 203 is shown on the label supporter 206 that is disposed proximate to the separation plate 205. As the label 201 is gradually removed from the label sheet 203 the label 201 is transferred to the label supporter 206.

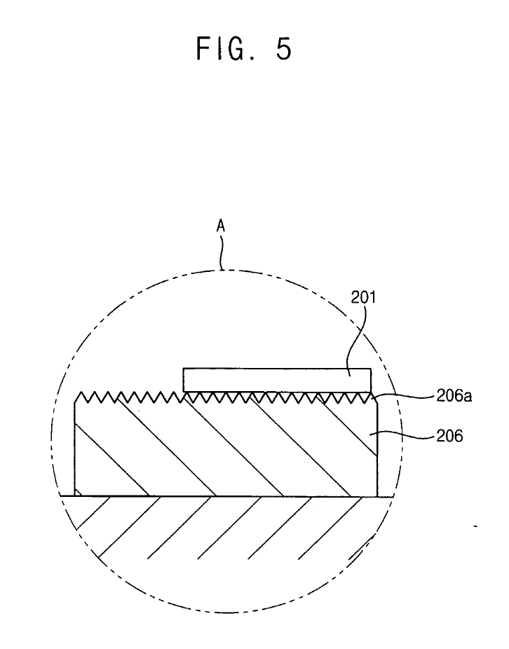

FIG. 5 is an enlarged cross-sectional view showing portion ‘A’ shown in FIG. 3.

Referring to FIG. 5, the label supporter 206 may have a substantially plate shape to support the label 201. An embossed portion 206a may be formed on a surface of the label supporter 206 that comes into contact with the label 201. As shown in FIG. 5, the embossed portion 206a includes a plurality of protrusions extending from the label supporter 206. The protrusions are shown substantially “V”-shaped. Apexes or ridges of the protrusions essentially form the surface of the label supporter 206 that contacts the label 201. The ridges of the embossed portion 206a decrease a contact surface between the label supporter 206 and the label 201 such that the label 201 may not become attached to the label supporter 206. While protrusions forming a ridge are described as “V”-shaped, it should be understood that any of a number of shapes of the protrusions may be used as is suitable to decrease a contact surface between the label supporter 206 an the label 201.

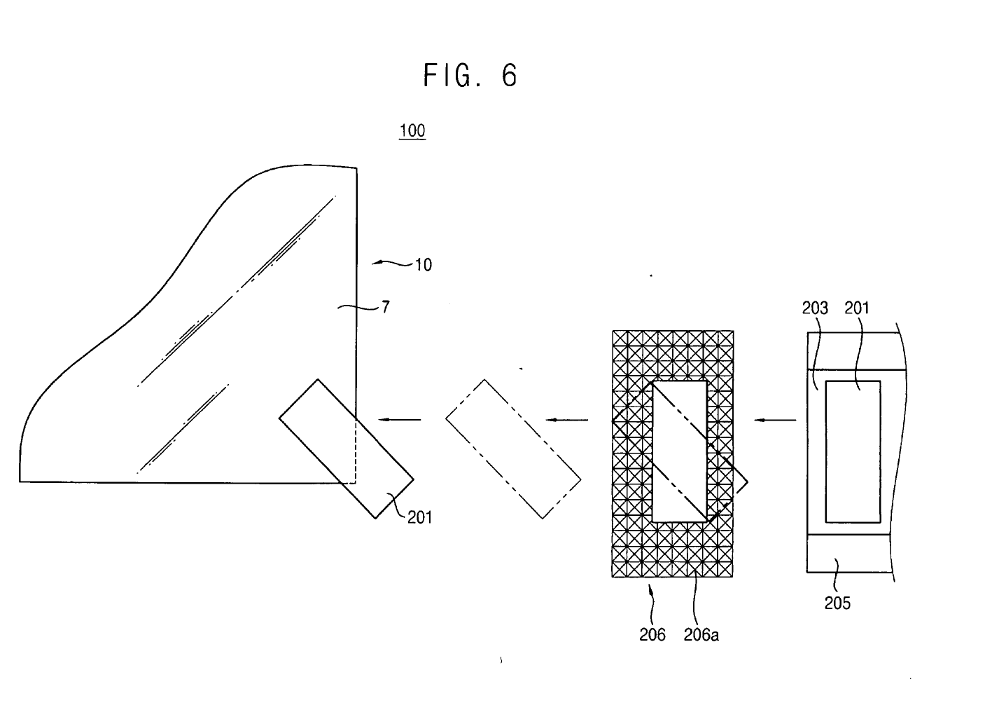

FIG. 6 is a plan view showing an exemplary embodiment of a label that is labeled on the protection sheet using a label picker shown in FIG. 3.

Referring to FIGS. 3 and 6, the label picker 220 of the labeling unit 200 picks up the label 201 that is on the label supporter 206, and transports the label 201 to an upper surface of the protection sheet 7 of the display panel 10. The label picker 220 is on the base 222. In one exemplary embodiment, the label picker 220 may pick up the label 201 using a vacuum pickup. The label picker 220 may include a transporting part to vacuum pick up the label 201. In addition, the label picker 220 may also include a label rotating part so that the label 201 is rotated from its original position on the label supporter 206. In another exemplary embodiment, the label 201 may be transported and positioned from the label supporter 206 to be ultimately protruded from and extending over the corner of the protection sheet 7 as illustrated in FIG. 6.

The label rotating part may rotate in a substantially diagonal direction relative to edges of the display panel 10 such that the label 201 is also rotated to a direction substantially parallel with the diagonal direction of the display panel 10. Advantageously, when the label 201 is attached to the protection sheet 7 in the diagonal direction of the display panel 10, the protection sheet 7 may be easily detached from the polarizer 6. In one exemplary embodiment, a longitudinal direction of the label 201 may be substantially in parallel with the diagonal direction of the display panel 10. In other exemplary embodiments, a central line along a longitudinal direction of the label 201 may be shifted with respect to a diagonal line of the display panel 10 as is suitable for facilitating removal of the protection sheet 7 from the display panel 10.

The compressing part 230 of the labeling unit 200 is on the base 222 adjacent to the label picker 220. In one exemplary embodiment, the compressing part 230 includes a roller. The compressing part 230 compresses or applies a force to an upper surface of the label 201 that is initially placed on the protection sheet 7 of the display panel 10 such that the label 201 is securely attached to the protection sheet 7. In another exemplary embodiment, the labeling unit 200 may further include a transporting part that transports the compressing part 230.

The labeling unit 200 attaches the label 201 to the protection sheet 7 that is on the polarizer 6 of the display panel 10. The protection sheet 7 may then be stripped by the clamping unit 300.

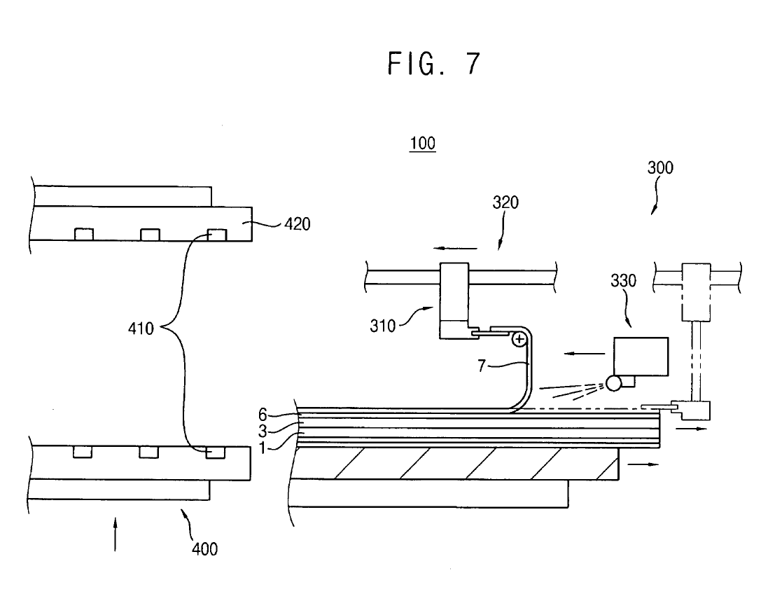

FIG. 7 is a cross-sectional view showing an exemplary embodiment of a clamping unit shown in FIG. 2.

Referring to FIG. 7, the clamping unit 300 includes a clamping part 310, a clamp transporting part 320 and a static charge discharging part 330.

The clamping part 310 may further include a gripping part that grips the label 201 that is attached to the protection sheet 7.

The clamp transporting part 320 may transport the clamping part 310 that is fixed to or gripping a portion the label 201 such that the protection sheet 7 is removed or stripped from the polarizer 6 as is shown by the arrow in FIG. 7. In order to decrease a time period for stripping the protection sheet 7, the display panel 10 may be transported by a transporting member in a direction substantially similar to a direction of placement of the label 201 as indicated by the arrows in FIG. 7. In one exemplary embodiment, the clamping part 310 and/or the display panel 10 may be transported in a diagonal direction relative to the display panel 10 when the label 201 is placed substantially in the diagonal direction of the display panel 10 as described above. In an alternative exemplary embodiment, both the clamping part 310 and the display panel 10 may be transported in appropriate directions substantially simultaneously to further decrease a time period for removing the protection sheet 7 from the display panel 10.

When the protection sheet 7 is stripped from the polarizer 6, a static charge may be stored between the protection sheet 7 and the polarizer 6. A transistor of the display panel 10 may be damaged by the static charge.

The static charge discharging part 330 may be disposed on the body 100 to discharge the static charge between the protection sheet 7 and the polarizer 6.

The static charge discharging part 330 may be transported and placed between the polarizer 6 and the protection sheet 7 that is detached from the polarizer 6 as the protection sheet 7 is being removed from the polarizer 6 as is indicated by the arrow in FIG. 7. The static charge discharging part 330 may include a nozzle that sprays negative ions or positive ions. In another exemplary embodiment, a plurality of static charge discharging parts 330 that are spaced apart from each other may be positioned between the polarizer 6 and the protection sheet 7 that is detached from the polarizer 6 such that a location of the static charge discharging parts 330 is not required to changed and/or the static charge discharging parts 330 are not transported.

The ions from the static charge discharging part 330 removes the static charge that is charged between the protection sheet 7 and the polarizer 6.

The protection sheet 7 that is removed from the polarizer 6 is transported to a protection sheet stacking unit 400. The protection sheet stacking unit 400 may further include a vacuum hole 410 on a lower part of the protection sheet stacking unit 400 to facilitate holding of the protection sheet 7 while located on the protection sheet stacking unit 400. In another exemplary embodiment, the protection sheet stacking unit 400 may further include a protection sheet ejecting part 420 so that the protection sheet 7 may be removed from the protection sheet stacking unit 400. The protection sheet ejecting parts 420 may also include a vacuum hole 410 to facilitate holding of the protection sheet 7 while being transported from the protection sheet stacking unit 400. The protection sheet ejecting part 420 may press a plurality of protection sheets 7 together such that the protection sheets 7 essentially become attached to each other, further facilitating ejection of the protection sheets 7 from the protection sheet stacking unit 400.

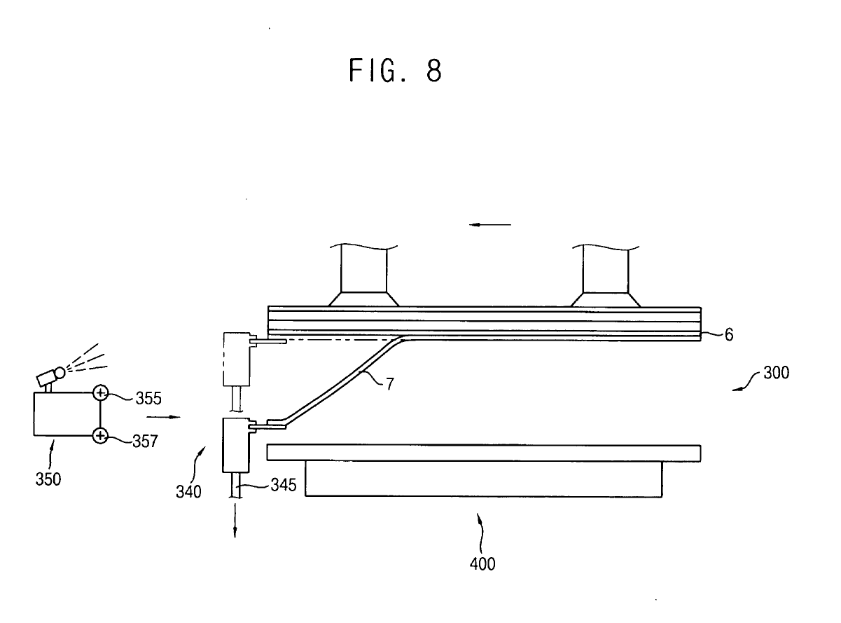

FIG. 8 is a cross-sectional view showing another exemplary embodiment of a clamping unit in accordance with f the present invention.

Referring to FIG. 8, the clamping unit 300 may include a clamping part 340, a clamp transporting part 345 and a static charge discharging part 350. The clamping unit 300 strips a protection sheet 7 that is attached to a polarizer 6 disposed on a lower surface of a display panel 10.

The clamping part 340 may further include a gripping part to grip a label 201 that is attached to the protection sheet 7.

The clamp transporting part 345 transports the clamping part 340 towards the display panel 10, the clamping part 340 grip the label 201 attached to the protection sheet 7 and the clamp transporting part 345 further transports the clamping part 340 away from the display panel 10 such that the protection sheet 7 is initially detached from the polarizer 6. The clamping part 340 may be transported in substantially a vertical direction as indicated by the arrows in FIG. 8 to initially detach the protection sheet 7 from the display panel 10 and/or further remove the protection sheet from the polarizer 6. In another exemplary embodiment, the clamp transporting part 345 may also transport the clamping part 340 in a substantially horizontal direction toward an opposite side of the polarizer 6 such that the protection sheet 7 is detached from the polarizer 6. In another exemplary embodiment, the display panel 10 may be transported by a transporting member in a direction appropriate relative to the label 210 placement as further indicated by the arrow in FIG. 8 to remove the protection sheet 7 from the polarizer 6 In an alternative exemplary embodiment, both the clamping part 340 and the display panel 10 may be transported in appropriate directions substantially simultaneously to further decrease a time period for removing the protection sheet 7 from the display panel 10.

When the protection sheet 7 is stripped from the polarizer 6, a static charge may be stored between the protection sheet 7 and the polarizer 6. A transistor of a display panel 10 may be damaged by the static charge.

A static charge discharging part 350 may be adjacent to the clamping unit 300 to discharge the static charge between the protection sheet 7 and the polarizer 6.

The static charge discharging part 350 may be disposed between the polarizer 6 and the protection sheet 7 that is detached from the polarizer 6. The static charge discharging part 350 may include a nozzle that sprays negative ions or positive ions.

The ions from the static charge discharging part 350 removes the static charge that is charged between the protection sheet 7 and the polarizer 6.

In FIG. 8, the static charge discharging part 350 is transported between the polarizer 6 and the protection sheet 7 to separate the protection sheet 7 from the polarizer 6. The protection sheet 7 is essentially detached from the polarizer 6 by the static charge discharging part 350. The static charge discharging part 350 may include a first roller 355 and a second roller 357 so as to prevent the protection sheet 7 from becoming attached to the static charge discharging part 350.

The protection sheet 7 that is detached from the polarizer 6 by the clamping part 340 and the static charge discharging part 350 of the clamping unit 300 may be aligned on a protection sheet stacking unit 400. The second roller 357 may press the protection sheet 7 that is detached from the polarizer 6 by the first roller 355 onto an upper surface of the protection sheet stacking unit 400. In FIG. 8, a plurality of protection sheets 7 may be stacked on the protection sheet stacking unit 400, and the protection sheet stacking unit 400 may be transported or moved, such as being turned upside down, such that the stacked protection sheets 7 may be ejected from the protection sheet stacking unit 400.

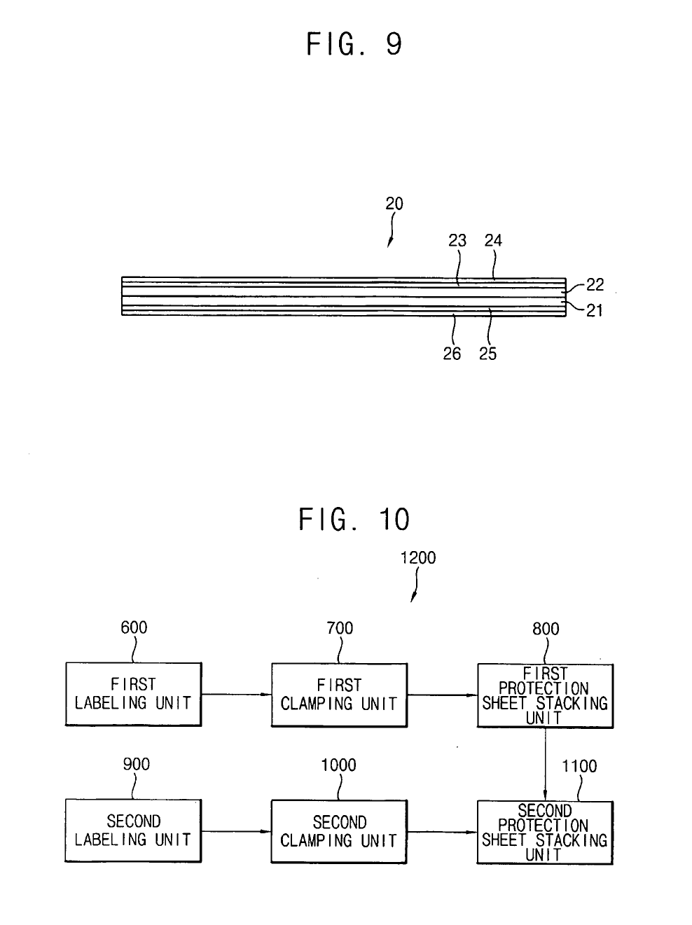

FIG. 9 is a cross-sectional view showing another exemplary embodiment of a display panel including a protection sheet that may be removed by an apparatus for removing the protection sheet in accordance with the present invention.

Referring to FIG. 9, the display panel 20 includes a thin film transistor (TFT) substrate 21, a color filter substrate 22 corresponding to the TFT substrate 21, a liquid crystal layer (not shown), a first polarizer 23, a second polarizer 25, a first protection sheet 24 and a second protection sheet 26. The liquid crystal layer (not shown) is interposed between the TFT substrate 21 and the color filter substrate 22. The display panel 20 may have a substantially rectangular shape when viewed on a plane.

In FIG. 9, the first polarizer 23 is on the color filter substrate 22, and the first protection sheet 24 is on the first polarizer 23. The second polarizer 25 is on the TFT substrate 21, and the second protection sheet 26 is on the second polarizer 25. Each of the first and second polarizers 23 and 25 and the first and second protection sheets 24 and 26 has a substantially same shape as the display panel 20.

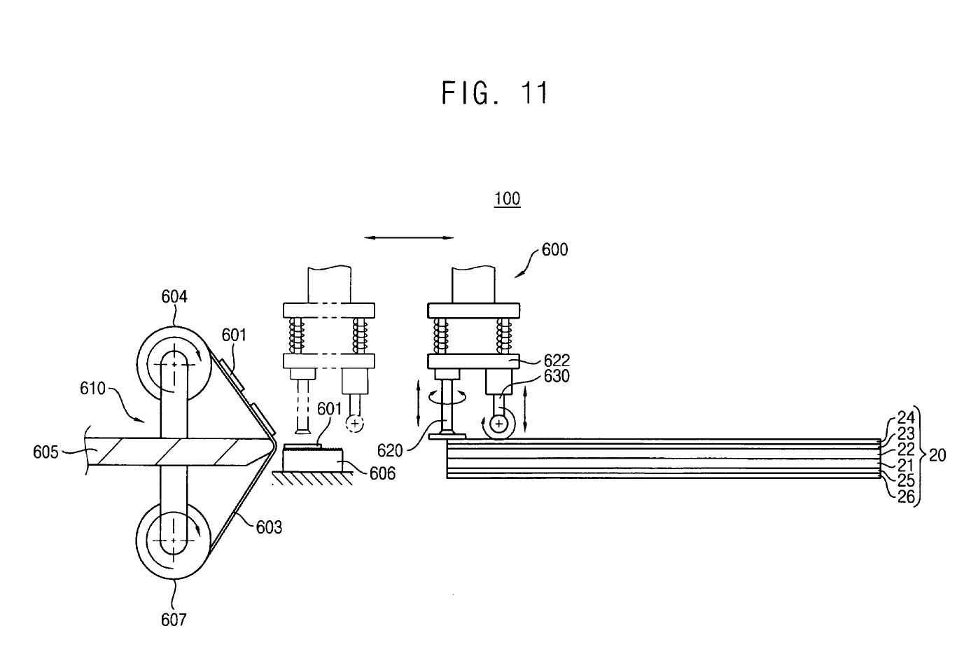

FIG. 10 is a block diagram showing another exemplary embodiment of the apparatus for removing a protection sheet in accordance with the present invention. FIG. 11 is a cross-sectional view showing an exemplary embodiment of a labeling unit shown in FIG. 10.

Referring to FIGS. 10 and 11, the apparatus 1200 for removing the protection sheet includes a body 100, a first labeling unit 600, a first clamping unit 700, a first protection sheet stacking unit 800, a second labeling unit 900, a second clamping unit 1000 and a second protection stacking unit 1100. The apparatus 1200 for removing the protection sheet may continuously strip the first and second protection sheets 24 and 26 from the first and second polarizers 23 and 25.

The first and second labeling units 600 and 900, the first and second clamping units 700 and 1000 and the first and second protection sheet stacking units 800 and 1100 are mounted on the body 100.

Referring again to FIG. 11, the first labeling unit 600 attaches a first label 601 to the first protection sheet 24 that is attached to the first polarizer 23. In one exemplary embodiment, the first labeling unit 600 attaches the first label 601 adjacent a corner of the first protection sheet 24.

The first labeling unit 600 includes a first label separating part 610, a first label picker 620 and a first compressing part 630.

The first label separating part 610 includes a first label sheet roll 604, a first separation plate 605, a first label supporter 606 and a first label sheet collecting roll 607. A first label sheet 603 having the first label 601 on a surface of the first label sheet 603 is rolled in the first label sheet roll 604. The first separation plate 605 assists in removing the first label 601 from the first label sheet 603 as the label sheet is processed over a side or edge of the first separation plate 605. The first label supporter 606 supports the first label 601 that is separated from the first label sheet 603. The first label sheet collecting roll 607 collects the first label sheet 603 from which the first label 601 is removed.

The first label sheet roll 604 is disposed on or over the first separation plate 605, and the first label sheet collecting roll 607 is under the first separation plate 605. The first label sheet roll 604 may also be considered as corresponding to the first label sheet collecting roll 607 with respect to the first separation plate 605. A driving motor (not shown) is mounted on the first label sheet collecting roll 607 such that the first label sheet 603 is transported from the first label sheet roll 604 toward the first label sheet collecting roll 607.

The first label sheet 603 having the first label 601 is essentially bent by the first separation plate 605 so that the first label 601 is separated from the first label sheet 603. In one exemplary embodiment, the label sheet 603 is bent as it passes over a surface or an edge of the separation plate. That is, the first label 601 is gradually separated from the first label sheet 603 by the first separation plate 605.

In exemplary embodiments, the first label sheet 603 may have a substantially rectangular tape shape, and the first label 601 is on the surface of the first label sheet 603. The first label 601 may have a substantially rectangular shape when viewed on a plane, and a longitudinal direction of the first label 601 may be substantially in parallel or perpendicular to a longitudinal direction of the first label sheet 603.

The first label 601 that is separated from the first label sheet 603 is transferred onto the first label supporter 606 that is disposed proximate to or on the first separation plate 605. The first label supporter 606 may have a substantially plate shape to support the first label 601. An embossed portion may be formed on a side or surface of the first label supporter 606 that comes into contact with the label. The first label 601 makes contact with only ridges of the embossed portion to decrease a contact surface between the first label supporter 606 and the first label 601 such that the first label 601 may not become attached to the first label supporter 606.

The first label picker 620 of the first labeling unit 600 picks up the first label 601 that is on the first label supporter 606, and transports the first label 601 to an upper surface of the first protection sheet 24 of the display panel 20. The first label picker 620 is on the first base 622. In one exemplary embodiment, the first label picker 620 may pick up the first label 601 using a vacuum pickup. The first label picker 620 may include a transporting part to vacuum pick up the first label 601. In addition, the first label picker 620 may also include a label rotating part (not shown) so that the first label 601 is rotated from its original position on the first label supporter 606.

The first label rotating part (not shown) may rotate with respect to a substantially diagonal direction relative to edges of the display panel 20 such that the first label 601 is also rotated substantially to the diagonal direction. Advantageously, when the first label 601 is attached to the first protection sheet 24 in the diagonal direction, the first protection sheet 24 may be easily detached from the first polarizer 23. In one exemplary embodiment, a longitudinal direction of the first label 601 may be substantially in parallel with the diagonal direction of the display panel 20. In another exemplary embodiment, a central line along a longitudinal direction of the first label 601 may be shifted with respect to a diagonal line of the display panel 20 as is suitable for facilitating removal of the first protection sheet 24 from the display panel 20.

The first compressing part 630 of the first labeling unit 600 is on the first base 622 adjacent to the first label picker 620. In one exemplary embodiment, the first compressing part 630 includes a roller. The first compressing part 630 compresses or applies a force to an upper surface of the first label 601 that is initially placed on the first protection sheet 24 of the display panel 20 such that the first label 601 is securely attached to the first protection sheet 24. In another exemplary embodiment, the first labeling unit 600 may further include a transporting part that transports the first compressing part 630.

The first labeling unit 600 attaches the first label 601 to the first protection sheet 24 that is on the first polarizer 23. The first protection sheet 24 may then be stripped by the first clamping unit 700.

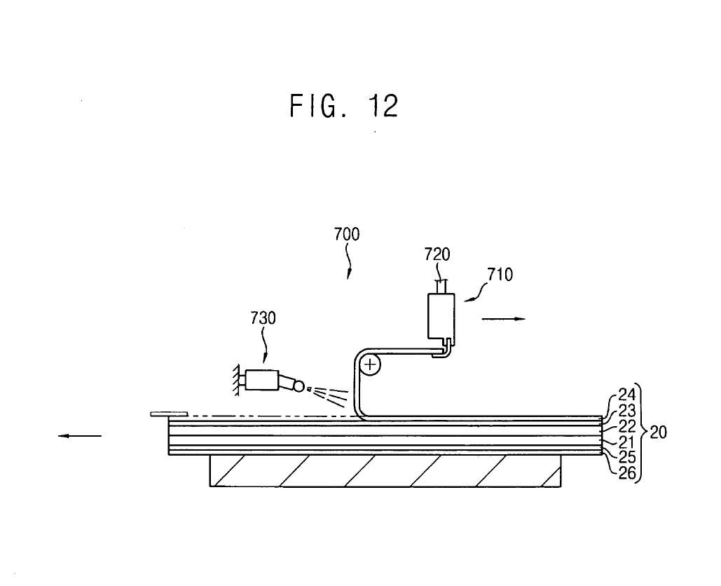

FIG. 12 is a cross-sectional view showing an exemplary embodiment of +a first clamping unit shown in FIG. 10.

Referring to FIG. 12, the first clamping unit 700 includes a first clamping part 710, a first clamp transporting part 720 and a first static charge discharging part 730.

The first clamping part 710 may further include a gripping part that grips the first label 601 that is attached to the first protection sheet 24.

The first clamp transporting part 720 may transport the first clamping part 710 that is fixed to or gripping a portion of the first label 601 in a position above the first protection sheet 24 such that the first protection sheet 24 is removed or stripped from the first polarizer 23 as is shown by the arrow in FIG. 12. In order to decrease a time period for stripping the first protection sheet 24, the display panel 20 may be transported by a transporting member in a direction substantially similar to a direction of placement of the first label 601 as indicated by the arrow in FIG. 12. In one exemplary embodiment, the first clamping part 710 and/or the display panel 20 may be transported in a diagonal direction relative to the display panel 20. The apparatus 100 may further include a display panel transporting member that transports the display panel 20 in substantially opposite direction to the first clamping unit 700. In an alternative exemplary embodiment, both the first clamping part 710 and the display panel 20 may be transported in appropriate directions substantially simultaneously to further decrease a time period for removing the first protection sheet 24 from the display panel 20.

When the first protection sheet 24 is stripped from the first polarizer 23, a static charge may be stored between the first protection sheet 24 and the first polarizer 23. A transistor of the display panel 20 may be damaged by the static charge.

The first static charge discharging part 730 may be disposed on the body 100 to discharge the static charge between the first protection sheet 24 and the first polarizer 23.

The first static charge discharging part 730 may be transported and placed between the first polarizer 23 and the first protection sheet 24 that is detached from the first polarizer 23 as the first protection sheet 24 is being removed from the first polarizer 23. The first static charge discharging part 730 may include a nozzle that sprays negative ions or positive ions between the first polarizer 23 and the first protection sheet 24 as the first protection sheet 24 is being removed from the first polarizer 23.

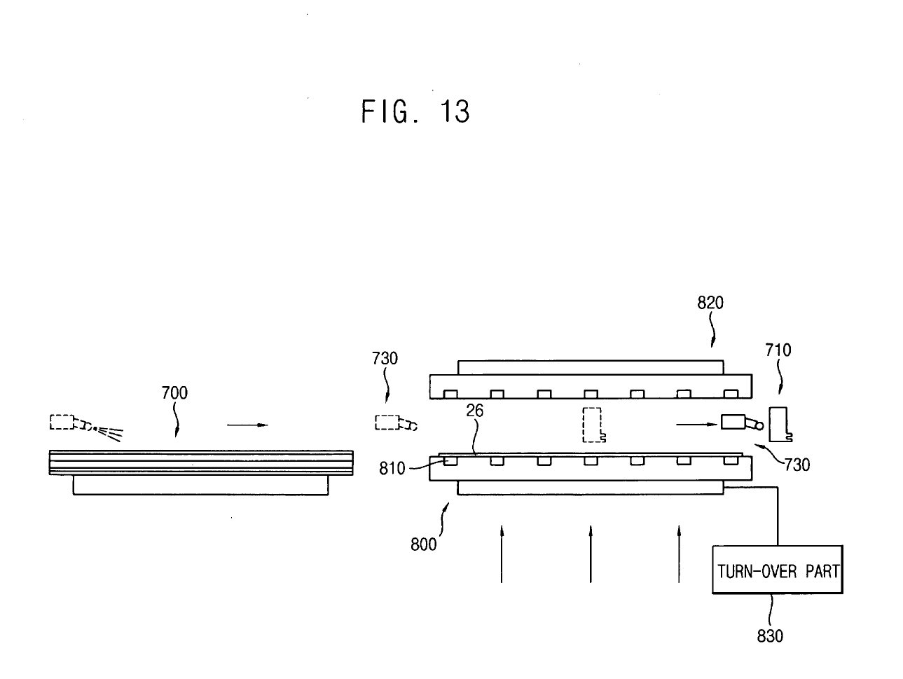

The ions from the first static charge discharging part 730 removes the static charge that is charged between the first protection sheet 24 and the first polarizer 23. FIG. 13 is a cross-sectional view showing an exemplary embodiment of a first protection sheet stacking unit shown in FIG. 10.

Referring to FIG. 13, the first protection sheet 24 that is removed from the first polarizer 23 is transported to the first protection sheet stacking unit 800. The first protection sheet stacking unit 800 may further include a first vacuum hole 810 to facilitate holding of the first protection sheet 24 while located on the first protection sheet stacking unit 800. In another exemplary embodiment, the first protection sheet stacking unit 800 may further include a first protection sheet ejecting part 820 so that the first protection sheet 24 may be removed from the first protection sheet stacking unit 800. The first protection sheet ejecting part 820 may also include a first vacuum hole 810 to facilitate holding of the first protection sheet 24 while being moved or transported. The first protection sheet ejecting part 820 may press a plurality of first protection sheets 24 together such that the stacked first protection sheets 24 essentially become attached to each other. A turn-over part 830 turns the stacked first protection sheets 24 upside down such that the stacked first protection sheets 24 may be dropped or discarded.

The first static discharging part 730 of the first clamping unit 700 may be aligned on the first protection sheet stacking unit 800 or may be transported or moved proximate to the first protection sheet 24 during and after it is removed from the first polarizer 23. In one exemplary embodiment, the first static discharging part 730 may follow the first clamping part 710 from the first clamping unit 700 to the first protection sheet stacking unit 800 to remove the static charge that is may be present on the stacked first protection sheets 24 as shown by the arrows in FIG. 13.

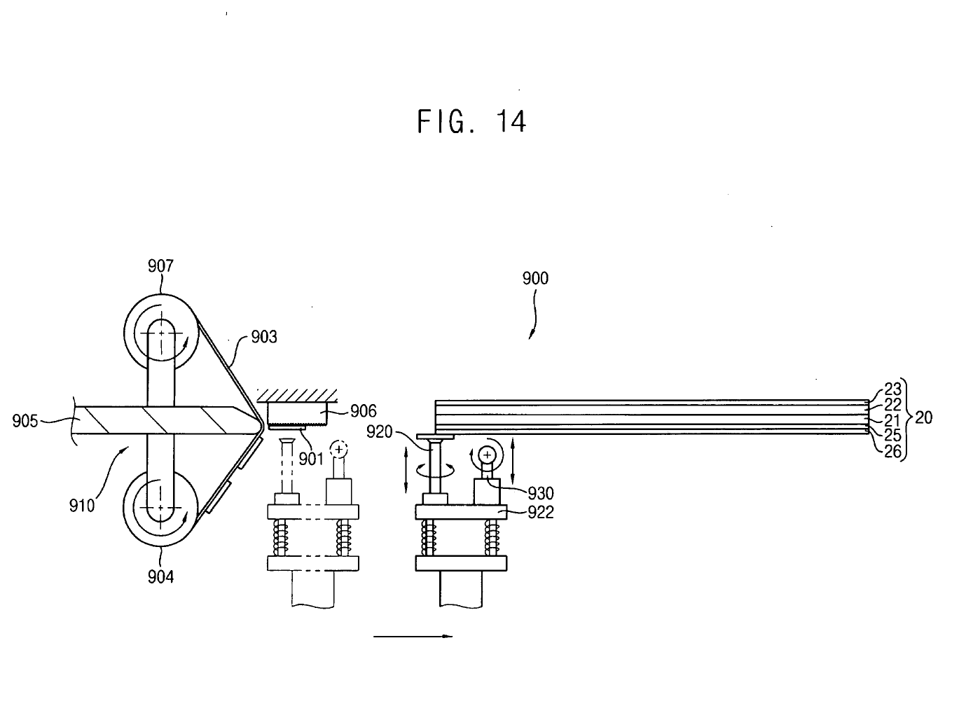

FIG. 14 is a cross-sectional view showing an exemplary embodiment of a second protection sheet stacking unit shown in FIG. 10.

Referring to FIG. 14, the second labeling unit 900 attaches a second label 901 to the second protection sheet 26 that is attached to the second polarizer 25. The second label 901 may be placed at any of a number of locations on the second protection sheet 26. In one exemplary embodiment, the second labeling unit 900 attaches the second label 901 adjacent a corner of the second protection sheet 26.

The second labeling unit 900 includes a second label separating part 910, a second label picker 920 and a second compressing part 930.

The second label separating part 910 includes a second label sheet roll 904, a second separation plate 905, a second label supporter 906 and a second label sheet collecting roll 907. A second label sheet 903 having the second label 901 on a surface of the second label sheet 903 is rolled in the second label sheet roll 904. The second separation plate 905 essentially removes the second label 901 from the second label sheet 903 as the second label sheet 903 is processed with the second separation plate 905. The second label supporter 906 supports the second label 901 that is separated from the second label sheet 903. The second label sheet collecting roll 907 collects the second label sheet 903 from which the second label 901 is removed.

The second label sheet roll 904 is shown disposed under the second separation plate 905, and the second label sheet collecting roll 907 is disposed on (or over) the second separation plate 905. The second label sheet roll 904 may be considered as corresponding to the second label sheet collecting roll 907 with respect to the second separation plate 905. A driving motor (not shown) may be mounted on the second label sheet collecting roll 907 such that the second label sheet 903 is transported from the second label sheet roll 904 toward the second label sheet collecting roll 907.

The second label sheet 903 having the second label 901 is essentially bent by the second separation plate 905 such that the second label 901 is separated from the second label sheet 903. In one exemplary embodiment, the second label sheet 903 is bent as it passes over a surface or an edge of the second separation plate 905. That is, the second label 901 may be gradually separated from the second label sheet 903 by the second separation plate 905.

The second label sheet 903 may have a substantially rectangular tape shape, and the second label 901 may be temporarily or removably attached to a surface of the second label sheet 903. The second label 901 may have a substantially rectangular shape when viewed on a plane, and a longitudinal direction of the second label 901 may be substantially in parallel or perpendicular to a longitudinal direction of the second label sheet 903.

The second label 901 that is separated from the second label sheet 903 is placed on the second label supporter 906 that is on the second separation plate 905 after it is removed from the second label sheet 903. The second label supporter 906 may have a substantially plate shape to support the second label 901, and an embossed portion may be formed on a surface of the second label support 906 that comes into contact with the second label 901. The second label 901 may make contact with only ridges or protruding edges of the embossed portion to decrease a contact surface between the second label supporter 906 and the second label 901 so that the second label 901 may not become attached to the second label supporter 906.

The second label picker 920 of the second labeling unit 900 picks up the second label 901 that is on the second label supporter 906, and transports the second label 901 to an upper surface of the second protection sheet 26 of the display panel 20. The second label picker 920 is on the second base 922. In one exemplary embodiment, the second label picker 920 may pick up the second label 901 using a vacuum pickup. The second label picker 920 may include a transporting part to vacuum pick up the second label 901. In addition, the second label picker 920 may also include a label rotating part (not shown) so that the second label 901 is rotated from its original position on the second label supporter 906.

The second label rotating part (not shown) may rotate in a direction that is substantially in parallel with the diagonal direction of the display panel 20 so that the second label 901 also is rotated to a direction substantially parallel with the diagonal direction of the display panel 20. Advantageously, when the second label 901 is attached to the second protection sheet 26 in the diagonal direction, the second protection sheet 26 may be easily detached from the second polarizer 25. In one exemplary embodiment, a longitudinal direction of the second label 901 may be substantially in parallel with the diagonal direction of the display panel 20. In other exemplary embodiments, a central line of the second label 901 may be shifted with respect to a diagonal line of the display panel 20.

The second compressing part 930 of the second labeling unit 900 is on the second base 922 adjacent to the second label picker 920. In one exemplary embodiment, the second compressing part 930 includes a roller. The second compressing part 930 compresses or applies a force to an upper surface of the second label 901 that is initially placed on the second protection sheet 26 of the display panel 20 such that the second label 901 is securely attached to the second protection sheet 26. In another exemplary embodiment, the second labeling unit 900 may further include a transporting part that transports the second compressing part 930.

The second labeling unit 900 attaches the second label 901 to the second protection sheet 26 that is on the second polarizer 25. The second protection sheet 26 may then be stripped by the second clamping unit 1000.

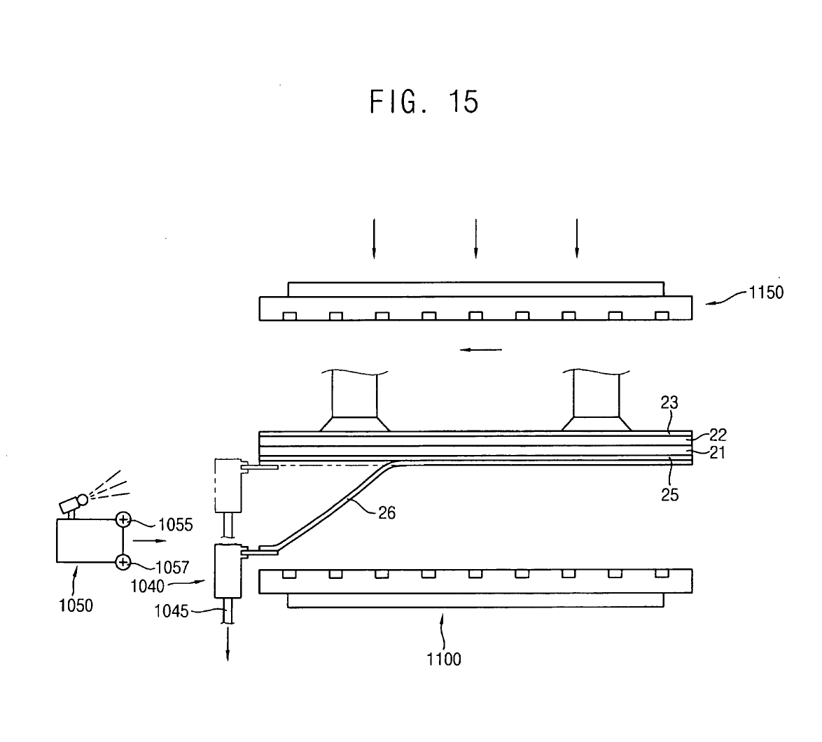

FIG. 15 is a cross-sectional view showing another exemplary embodiment of a clamping unit in accordance with the present invention.

Referring to FIG. 15, a second clamping unit 1000 includes a second clamping part 1040, a second clamp transporting part 1045 and a second static charge discharging part 1050. In FIG. 15, the second clamping unit 1000 may also strip a second protection sheet 26 that is attached to a second polarizer 25 that is attached to a lower surface of a display panel 20.

The second clamping part 1040 may further include a gripping part that grips the second label 901 that is attached to the second protection sheet 26.

The second clamp transporting part 1045 transports the second clamping part 1040 towards the display panel 20, the second clamping part 1040 grips the second label 901 attached to the second protections sheet 26 and the clamp transporting part 1045 further transports the second clamping part 1040 away from the display panel 20 such that the second protection sheet 26 is initially stripped from the second polarizer 25. The second clamping part 1040 may be transported in substantially a vertical direction as indicated by the arrow in FIG. 15 to further detach the second protection sheet 26 from the second polarizer 25.

In one exemplary embodiment, the first and the second clamping parts may be the same clamping unit and be transported or positioned relative to the display panel in order to facilitate removal of both the first and the second protection sheets. In alternative embodiments, the display panel may be moved or positioned relative to the clamping unit such that the clamping unit may access both the first and second protection sheets. In another alternative embodiment, where the first and second clamping parts are different units, removal of the first and second protection sheets may be processed substantially simultaneously.

In an alternative exemplary embodiment, in order to decrease a time period for stripping the second protection sheet 26, the display panel 20 may be transported by a transporting member in an appropriate direction relative to the second label 901, such as in the diagonal direction of the display panel 20, as indicated by the left horizontal arrow shown in FIG. 15. In another exemplary embodiment, both the second clamping part 1040 and the display panel 20 may be transported substantially simultaneously to further decrease a time period for removing the second protection sheet 26 from the display panel 20.

When the second protection sheet 26 is stripped from the second polarizer 25, a static charge may be stored between the second protection sheet 26 and the second polarizer 25. A transistor of the display panel 20 may be damaged by the static charge.

The second static charge discharging part 1050 may be on the body to discharge the static charge between the second protection sheet 26 and the second polarizer 25.

The second static charge discharging part 1050 may be disposed between the second polarizer 25 and the second protection sheet 26 that is detached from the second polarizer 25. The second static charge discharging part 1050 may include a nozzle that sprays negative ions or positive ions between the second polarizer 25 and the second protection sheet 26.

The ions from the second static charge discharging part 1050 removes the static charge that is charged between the second protection sheet 26 and the second polarizer 25.

In FIG. 15, the second static charge discharging part 1050 may be transported between the second polarizer 25 and the second protection sheet 26 to separate the second protection sheet 26 from the second polarizer 25. The second protection sheet 26 is essentially detached from the second polarizer 25 by the second static charge discharging part 1050. The second static charge discharging part 1050 may include a first roller 1055 and a second roller 1057 so as to prevent or effectively reduce the second protection sheet 26 from becoming attached to the second static charge discharging part 1050.

The second protection sheet 26 that is detached from the second polarizer 25 by the second clamping part 1040 and the second static charge discharging part 1050 of the second clamping unit 1000 may be aligned on a second protection sheet stacking unit 1100. The second roller 1057 may press the second protection sheet 26 that is detached from the second polarizer 25 by the first roller 1055 onto an upper surface of the second protection sheet stacking unit 1100. A plurality of second protection sheets 26 may be stacked on the second protection sheet stacking unit 1100, and then the second protection sheet stacking unit 1100 may be transported or moved, such that the stacked second protection sheets 26 may be ejected from the second protection sheet stacking unit 1100.

The second protection sheet stacking unit 1100 may include a second protection sheet ejecting part 1150 which may press a plurality of second protection sheets 26 together such that the second protection sheets 26 essentially become attached to each other, further facilitating ejection of the second protection sheets 26 from the second protection sheet stacking unit 1100.

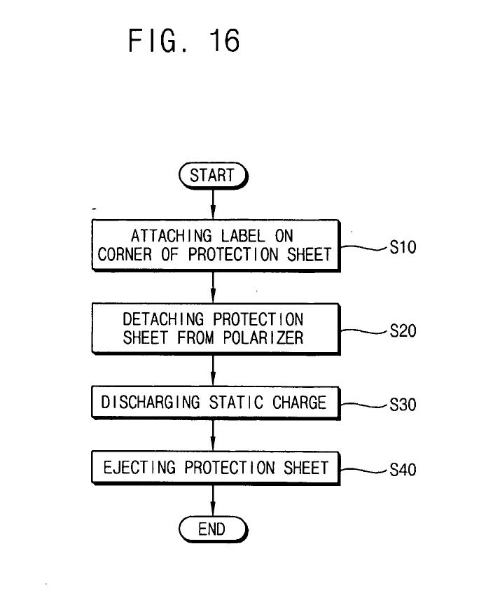

FIG. 16 is a flow chart showing an exemplary embodiment of a method of removing a protection sheet in accordance with the present invention.

Referring to FIG. 16, a label for stripping a protection sheet from a polarizer is attached to a corner of the protection sheet (step S10). An adhesive strength between the label and the protection sheet should be no more than an adhesive strength between the protection sheet and the polarizer.

In particular, the label is detached from a label sheet. The label is transported to the protection sheet. The label is pressed to be attached to the protection sheet.

The label that is attached to the protection sheet is moved or pulled so that the protection sheet is spaced apart or detached from the polarizer (step S20). The protection sheet ultimately becomes detached from the polarizer.

A material for discharging a static charge between the protection sheet and the polarizer is injected between the protection sheet and the polarizer, thereby discharging the static charge (step S30). The material for discharging a static charge may be applied during and/or after the protection sheet is removed from the polarizer. The material for discharging the static charge may include negative ions and/or positive ions.

The protection sheet that is removed from the polarizer is ejected (step S40).

In one exemplary embodiment according to the present invention, the protection sheet that is attached to the polarizer is easily removed from the polarizer. In addition, the static charge formed between the polarizer and the protection sheet may also be discharged. Furthermore, a time period for manufacturing the display device may be decreased. Advantageously, a yield of the display panel may be improved.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. An apparatus for removing a protection sheet comprising:
a body;
a labeling unit on the body attaching a label on a protection sheet disposed on polarizer of a display panel;
a clamping unit on the body, the clamping unit including:
a clamping part clamping the label; and
a clamp transporting part transporting the clamping part so that the protection sheet is stripped from the polarizer; and
a protection sheet stacking unit on the body receiving the protection sheet that is stripped from the polarizer.

2. The apparatus of claim 1, wherein the labeling unit further comprises:
a label separating part removing the label from a label source;
a label picker aligning the label on the protection sheet; and
a compressing part pressing the label on the protection sheet.

3. The apparatus of claim 2, wherein the label separating part comprises:
a label source collector, the label source being collected on the label source collector;
a separation plate removing the label from the label sheet; and
a label supporter supporting the label that is removed from the label source.

4. The apparatus of claim 3, wherein the label source is a sheet roll.

5. The apparatus of claim 3, wherein the label supporter comprises an embossed portion decreasing a contact surface between the label supporter and the label so that the label does not become attached to the label supporter.

6. The apparatus of claim 2, wherein the label has a substantially rectangular shape, and a longitudinal direction of the label is substantially perpendicular with a longitudinal direction of the label source.

7. The apparatus of claim 6, wherein the label picker further comprises a rotating part rotating the label picked by the label picker so that the label is protruded substantially from a corner of the protection sheet.

8. The apparatus of claim 2, wherein the compressing part further comprises:
a roller pressing the label on the protection sheet; and
a roller transporting part that transports the roller on the protection sheet.

9. The apparatus of claim 1, wherein the clamping unit further comprises a clamp transporting part transporting the label in a substantially vertical direction relative to the display panel.

10. The apparatus of claim 1, wherein the clamping part further comprises a roller transported between the protection sheet and the polarizer so that the protection sheet is detached from the polarizer.

11. The apparatus of claim 1, further comprising a display panel transporting unit transporting the display panel in substantially opposite direction to the clamping unit.

12. The apparatus of claim 1, further comprising a static charge discharging part spraying a material discharging a static charge between the polarizer and the protection sheet.

13. The apparatus of claim 12, wherein the material discharging the static charge comprises positive ions and/or negative ions.

14. The apparatus of claim 1, wherein the protection sheet stacking unit further comprises a protection sheet ejecting part ejecting the protection sheet received in the protection sheet stacking unit.

15. The apparatus of claim 14, wherein the protection sheet stacking unit is turned upside down so that the protection sheet received in the protection sheet stacking unit is ejected.

16. An apparatus for removing a protection sheet comprising:
a body;
a first labeling unit on the body attaching a first label on a first protection sheet disposed on a first polarizer of a first surface of a display panel;
a first clamping unit on the body, the first clamping unit including:
a first clamping part clamping the first label; and
a first clamp transporting part transporting the first clamping part so that the first protection sheet is detached from the first polarizer;
a first protection sheet stacking unit on the body receiving the first protection sheet that is detached from the first polarizer;
a second labeling unit on the body attaching a second label on a second protection sheet disposed on a second polarizer of a second surface of the display panel;
a second clamping unit on the body, the second clamping unit including:
a second clamping part clamping the second label; and
a second clamp transporting part transporting the second clamping part so that the second protection sheet is detached from the second polarizer; and
a second protection sheet stacking unit on the body receiving the second protection sheet that is detached from the second polarizer.

17. The apparatus of claim 16, further comprising a first static charge discharging part spraying a material discharging a static charge between the first polarizer and the first protection sheet.

18. The apparatus of claim 16, further comprising a second static charge discharging part spraying a material discharging a static charge between the second polarizer and the second protection sheet.

19. The apparatus of claim 16, wherein the first protection sheet stacking unit further comprises a first holding part that holds the first protection sheet.

20. The apparatus of claim 16, wherein the second protection sheet stacking unit further comprises a second holding part that holds the second protection sheet.

21. The apparatus of claim 20, wherein the second holding part is moved so that the second protection sheet received in the first protection sheet stacking unit is ejected.

22. A method for removing a protection sheet comprising:
attaching a label to a protection sheet disposed on a polarizer of a display panel;
moving the label so that the protection sheet is removed from the polarizer;
injecting a material discharging a static charge between the protection sheet and the polarizer; and
ejecting the protection sheet that is removed from the polarizer.

23. The method of claim 22, wherein the attaching the label comprises:
detaching the label from a label source;
transporting the label detached from the label source; and
pressing the label so that the label is attached to the protection sheet.

24. The method of claim 22, wherein the material discharging the static charge comprises positive ions and/or negative ions.
